(19) United States
(12) Patent Application Publication
(10) Pub. No.: US 2006/0007150 A1
(43) Pub. Date: Jan. 12, 2006

(54) Haptic feedback input device

(75) Inventors: Kazunobu Onodera, Miyagi-ken (JP); Takuya Maeda, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/145,860

(22) Filed: Jun. 6, 2005

(30) Foreign Application Priority Data
Jun. 7, 2004 (JP) 2004-168771

(51) Int. Cl. G09G 5/08

(52) U.S. Cl. 345/163

(57) ABSTRACT

A haptic feedback input device includes an operating section that is operated by a user, a motor that pivots in conjunction with the pivot operation of the operating section, a base that pivotably holds the motor via a pivot holder (motor supporting section), a cam member and driving rods (click feeling imparting unit) which impart a click feeling according to the pivot operation of the operating section. The pivot center of the motor is disposed below the center of gravity of the motor.

### BACKGROUND OF THE INVENTION

1. Field of the Invention

The present invention relates to a haptic feedback input device, and more particularly, to a haptic feedback input device, having a motor being directly and pivotably operated by an operating section to impart a feedback force, that can improve pivot operability of the motor.

2. Description of the Related Art

As an input device capable of collectively controlling various in-vehicle electrical apparatuses, such as an air conditioner, a radio, a television, a CD player, a navigation system, and the like, the inventors has been proposed a manual input device. Referring to FIG. 7, the manual input device includes a motor 102 that is pivotably attached to a frame 101, a manual operating section 103 that is attached to a motor driving shaft 102a, a first position sensor 104 that detects a pivot direction and a pivot distance of the motor 102, a second position sensor 105 that detects a rotation direction and a rotation distance of the motor driving shaft 102a, and a control section that receives position signals outputted from the first and second position sensors to control driving of the motor 102 and that imparts a feedback force according to an operating state of the manual operating section 103 to the manual operation section 103 (for example, see Japanese Unexamined Patent Application Publication No. 2002-149324).

In the above-described manual input device, the motor 102 is pivotably attached to the frame 101, the first sensor 104 detects the pivot direction and the pivot distance of the motor 102, and the second sensor 105 detects the rotation direction and the rotation distance of the motor 102. Therefore, for example, by changing the pivot direction of the motor 102, an in-vehicle electrical apparatus, a function of which is to be adjusted, is selected. Then, the function of the selected electrical apparatus according to the rotation distance of the motor driving shaft 102a is adjusted. As a result, with a single motor and a single manual operating section, a desired in-vehicle electrical apparatus can be selected and the function thereof can be adjusted.

Meanwhile, in a manual input device earlier proposed by the present inventors, the feedback force in accordance with the pivot direction and the pivot distance of the motor 102 and the feedback force in accordance with the rotation direction and the rotation distance of the motor driving shaft 102a are imparted by controlling the driving of the motor 102. However, instead of the above configuration, with respect to the feedback force imparted in accordance with the pivot direction and the pivot distance of the motor 102, a mechanical click feeling imparting unit may be used as a feedback force imparting unit. As an example of the above-mentioned mechanical click feeling imparting unit, it has been known a unit that includes a cam member having cam grooves and cam ridges, and a driving rod which comes into elastic contact with the cam grooves and the cam ridges. The mechanical click feeling imparting unit moves the cam member or the driving rod to run over the cam ridges in accordance with the pivot operation of the manual operating section and imparts the click feeling at that time to the manual operating section 103.

However, in this case, like the manual input device proposed by the present applicant, if the pivot center O of the motor 102 is disposed above the center of gravity G of the motor 102, a moment acts on the manual operating section 103 to return the motor 102 to the vertical position, when the manual operating section 103 is pivotably operated. Therefore, there is a disadvantage in that large force is required to pivotably operate the manual operating section 103 and the sensitivity of the click feeling imparted by the click feeling imparting unit deteriorates.

### SUMMARY OF THE INVENTION

The invention has been made in order to solve the above-described problems in the related art, and it is an object of the invention to provide a haptic feedback input device that can increase the difference between maximum and minimum values of resistance force by a click feeling imparting unit and can improve sensitivity of a click feeling.

In order to solve the above-described problems, according to an aspect of the invention, a haptic feedback input device includes an operating section that is rotatably and pivotably operated by a user, a motor that pivots in conjunction with the pivot operation of the operating section and that imparts a required feedback force in accordance with the rotation operation of the operating section to the operating section, a base that pivotably holds the motor via a motor supporting section, and a click feeling imparting unit that imparts a click feeling to the pivot operation of the operating section. A pivot center of the motor is disposed below a center of gravity of the motor.

As shown in FIG. 6, when the motor pivots by the pivot operation of the operating section in a state in which the motor is vertically held, resistance force in accordance with an elastic contact position of a driving rod against a cam member is imparted to the operating section. When the driving rod begins to run over cam ridges, the abrupt decrease in resistance force is imparted to the operating section as a click feeling. Further, if the operating section is further operated in a pivot direction after the click feeling is perceived, the driving rod hits a wall of the cam member, such that the resistance force acting on the operating section is infinitely increased.

If the pivot center of the motor is disposed above the center of gravity of the motor, the resistance force according to the click feeling imparting unit and a moment which tries to return the motor to a vertical position act on the operating section simultaneously. Therefore, as shown in the broken line in FIG. 6, the maximum value P3 of the resistance force when the driving rod begins to run over the cam ridges increases, while the minimum value Q3 increases beyond that amount, as compared to the case in which the pivot center of the motor and the center of gravity of the motor match with each other (shown in the one-dot-chain line in FIG. 6). As a result, the change in the resistance force H3 (P3-Q3), which is the click feeling of the operating section, becomes small and the sensitivity of the click feeling deteriorates. On the contrary, when the pivot center of the motor is disposed below the center of gravity of the motor, a moment which tries to rotate the motor in an inclined direction is generated, instead of the moment which tries to return the motor to the vertical position. Therefore, as shown in the solid line in FIG. 6, the maximum value P1 of the resistance force when the driving rod begins to run over the cam ridges decreases, while the minimum value Q1 further decreases beyond that amount, as compared to the case the pivot center of the motor and the center of gravity of the motor match with each other (shown in the one-dot-chain line in FIG. 6). As a result, the change in the resistance force H1 (P1-Q1), which is the click feeling of the operating section, becomes large and the sensitivity of the click feeling is improved.

Therefore, by disposing the pivot center of the motor below the center of gravity of the motor, the change H in the resistance force when the driving rod begins to run over the cam ridges can be increased to be larger than that when the pivot center of the motor is disposed above the center of gravity of the motor. Further, the operating feeling of the operating section can be improved. In addition, since the change H in the resistance force can be increased so as to impart the click feeling to the operating section, an elastic force to be imparted to a driving body can be decreased and wear resistance of the click feeling imparting unit can be improved.

Further, in the haptic feedback input device according to the aspect of the invention, it is preferable that the pivot center of the motor is disposed on an extended line of an output shaft of the motor.

As described above, if the pivot center of the motor is disposed on the extended line of the output shaft of the motor, when the operating section is pivotably operated, a moment proportional to the total weight of the motor can be imparted in an inclined direction of the motor. Therefore, when the operating section is pivotably operated, the total weight of the motor cannot be perceived by the operating section, and thus operability of the operating section can be further improved.

Further, in the haptic feedback input device according to the aspect of the invention, it is preferable that the motor can be pressibly held on the base.

As described above, if the motor can be pressibly held on the base, signals according to the press operation of the motor can be detected, thereby providing a multi-functional haptic feedback input device.

### BRIEF DESCRIPTION OF THE DRAWINGS

FIG. 1 is an exploded perspective view of a haptic feedback input device according to an embodiment of the invention;

FIG. 2 is an exploded perspective view of a planetary gear mechanism included in the haptic feedback input device according to the embodiment in an enlarged scale;

FIG. 3 is a plan view of a cam member included in the haptic feedback input device according to the embodiment;

FIG. 4 is a cross-sectional view of an assembled haptic feedback input device according to the embodiment;

FIG. 5 is a cross-sectional view of the haptic feedback input device according to the embodiment at the time of a pivot operation;

FIG. 6 is a graph showing a comparison result of advantages of the invention to those of the related art; and

FIG. 7 is a cross-sectional view of a haptic feedback input device according to the related art.

### DESCRIPTION OF THE PREFERRED EMBODIMENT

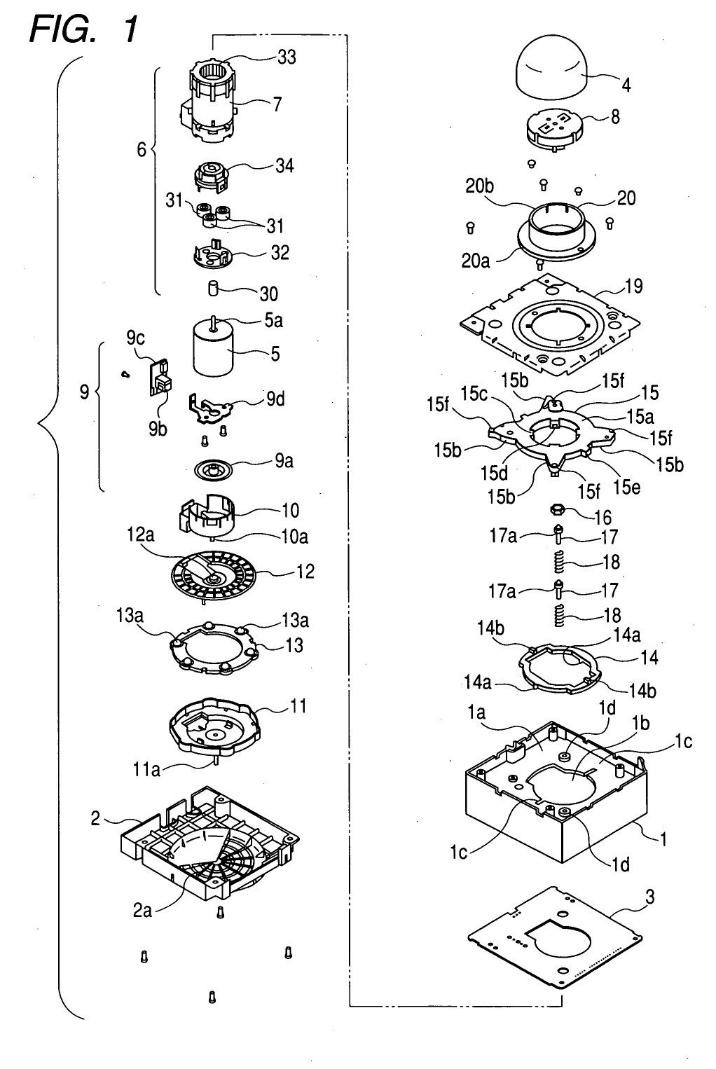

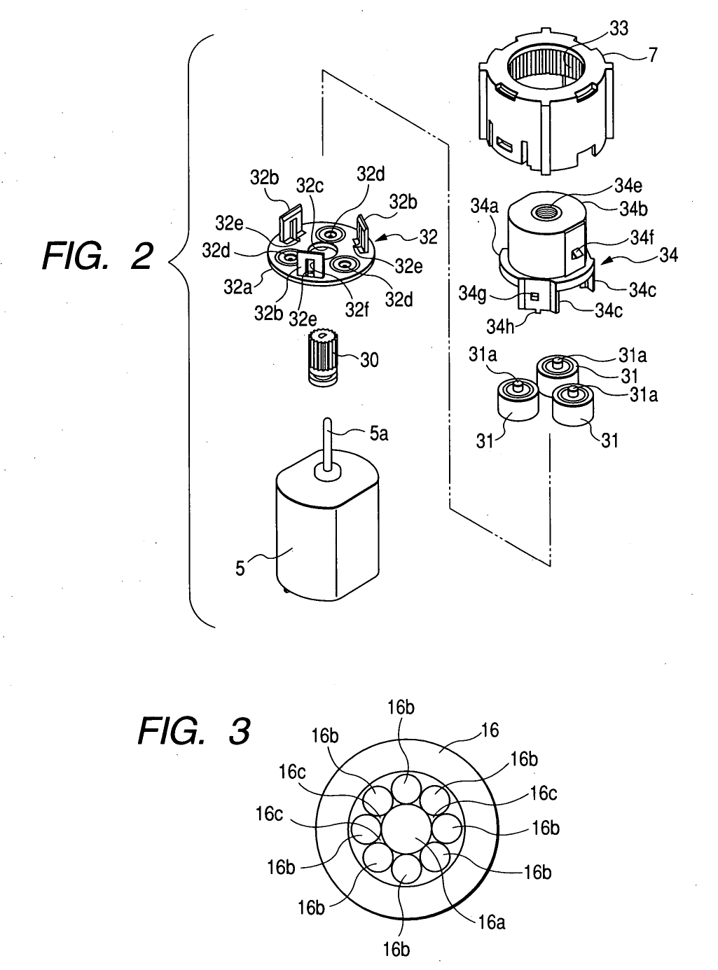

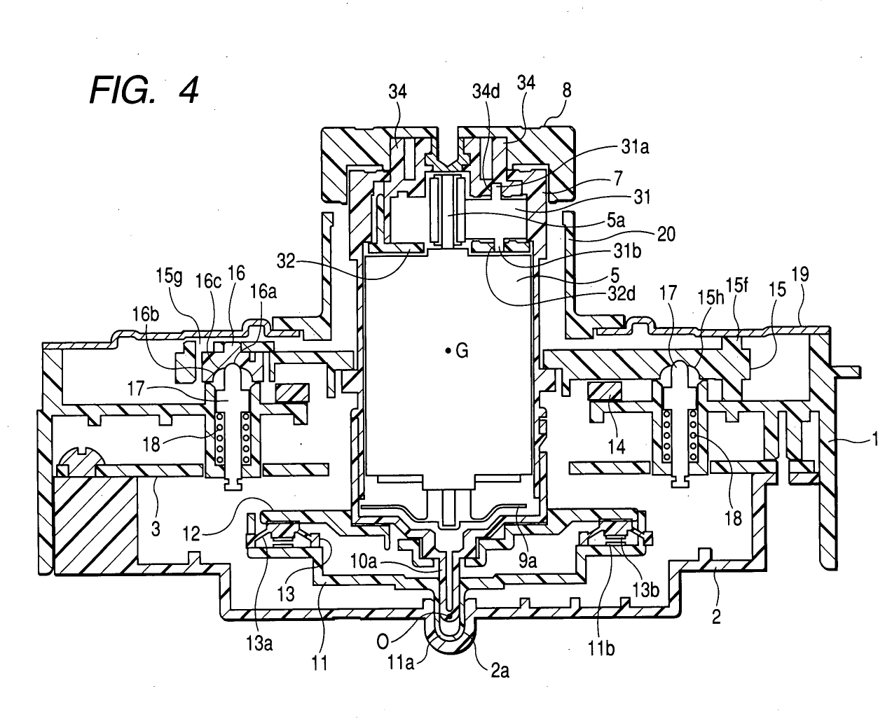

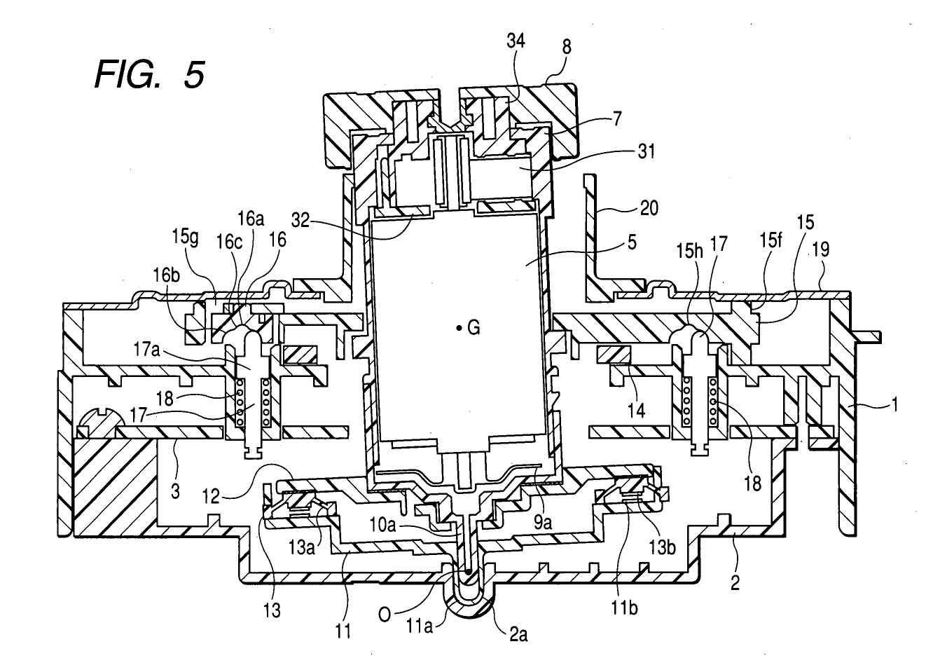

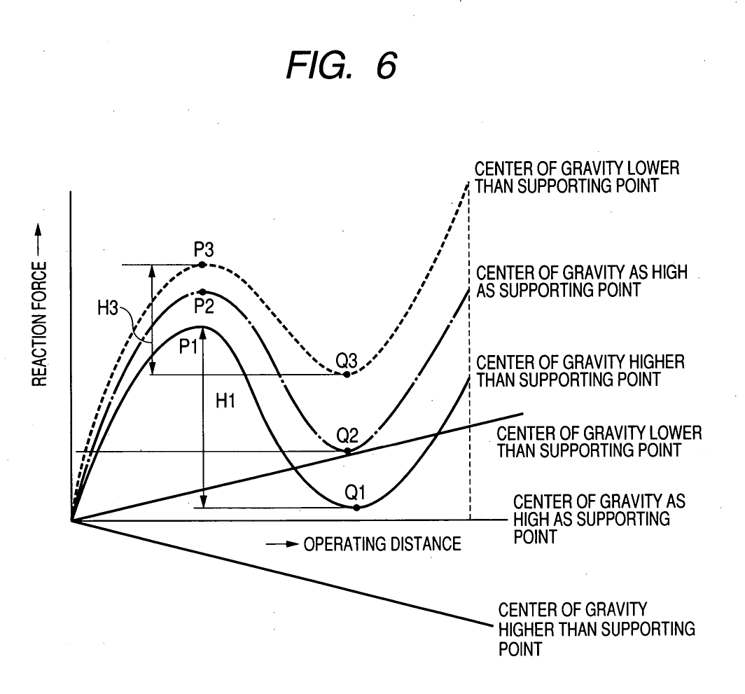

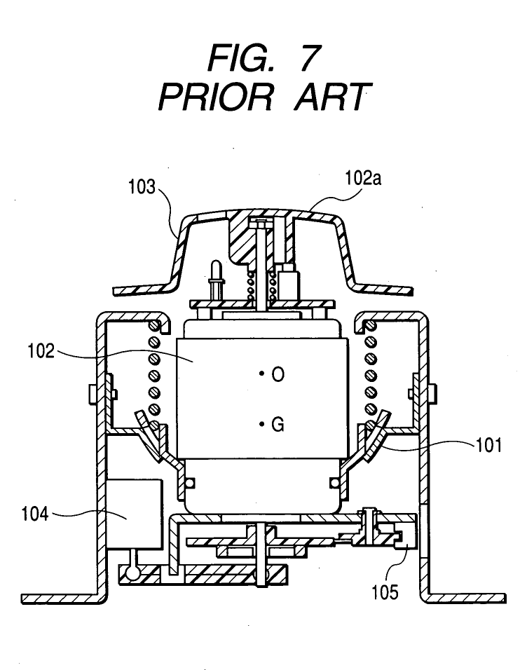

Hereinafter, an embodiment of a haptic feedback input device according to an embodiment of the invention will be described with reference to FIGS. 1 to 6. FIG. 1 is an exploded perspective view of a haptic feedback input device according to the embodiment. FIG. 2 is an exploded perspective view of a planetary gear mechanism included in the haptic feedback input device according to the embodiment in an enlarged scale. FIG. 3 is a plan view of a cam member included in the haptic feedback input device according to the embodiment. FIG. 4 is a cross-sectional view of the assembled haptic feedback input device according to the embodiment. FIG. 5 is a cross-sectional view of the haptic feedback input device according to the embodiment at the time of a pivot operation. FIG. 6 is a graph showing the comparison result of the advantages of the invention to those of the related art.

As shown in FIG. 1, the haptic feedback input device according to the embodiment includes a case 1, a base 2 that is attached to the lower portion of the case 1, a printed wiring board 3 that is housed in a space defined when the case 1 and the base 2 are assembled, an operating section 4 that is manually operated by a user, a motor 5 that supplies a required feedback force to the operating section 4, a planetary gear mechanism 6 that is disposed between the operating section 4 and the motor 5, a motor holder 7 that integrally holds the motor 5 and the planetary gear mechanism 6, a mounting member 8 that connects the operating section 4 to the motor holder 7, an encoder 9 that detects the rotation direction and the rotation distance of an output shaft 5a of the motor 5, an encoder holder 10 that integrally holds the motor 5 and the encoder 9, a pivot holder 11 that is pivotably disposed on the inner surface of the base 2 to pivotably hold the motor 5, a rubber pusher 12 that receives a press force of the operating section 4, a rubber spring 13 that is disposed between the pivot holder 11 and the rubber pusher 12 to impart a return force acting in an opposite direction to the press operation to the operating section 4, a lower slider 14 that is disposed on the upper surface of the case 1 to be engaged therewith and slides in a single direction of the case 1, an upper slider 15 that is engaged with the lower slider 14 and slides only in a direction orthogonal to the slide direction of the lower slider 14, a cam member 16 that is attached to the lower surface of the upper slider 15, two driving rods 17 that are set to be freely inserted into the case 1 and come into elastic contact with the cam member 16 and cam portions formed on the lower surface of the upper slider 15, springs 18 that constantly bias the driving rods 17 in a single direction, a cover member 19 that regulates the mounting height of the upper slider 15 to the case 1, and an extension cover 20 that is provided on the upper surface of the cover member 19.

The case 1 is made of synthetic resin and has a box shape having an upper surface plate 1a. In a substantially central portion of the upper surface plate 1a, a center hole 1b is opened, through which the motor holder 7 pivotably passes. Two guide grooves 1c that guide the lower slider 14 only in a single direction are formed on both sides from the center hole 1b in the upper surface of the upper surface plate 1a. In addition, the upper surface plate 1a has two receiving concave portions 1d that receive the driving rods 17 and the springs 18 that constantly bias the driving rods 17 upward and that are formed on both sides with respect to the center hole 1b of the upper surface plate 1a.

The base 2 is made of synthetic resin and has a cover shape that can be attached to the lower portion of the case 1. At a substantially central position of the base 2, a supporting hole 2a into which a pivot central shaft 11a formed on the lower surface of the pivot holder 11 is pivotably inserted is formed.

The printed wiring board 3 has a required circuit pattern (not shown) that is formed on at least one of surfaces of an insulating substrate. On the surface of the printed wiring board 3, required circuit components (not shown) are mounted according to a required arrangement.

The operating section 4 is manually operated by a user and is made of synthetic resin: The operating section 4 is formed so as to have an appropriate size and shape to be operated via fingers.

A rotational motor, such as a DC motor and the like, can be used as the motor 5. The motor 5 is driven and stopped according to signals from a control device (not shown) and imparts a required feedback force in accordance with the rotation operation of the operating section 4 to the operating section 4.

The planetary gear mechanism 6 has only synthetic resin-based components. As shown in FIG. 2, the planetary gear mechanism 6 includes a sun gear 30 that is fixed to the output shaft 5a of the motor 5, a plurality of planetary gears 31 (three gears in the present embodiment) that are engaged with the sun gear 30 and revolve around the sun gear 30, a regulating member 32 that regulates the movements of the planetary gears 31 in the shaft direction, a ring gear 33 that is formed on the inner surface of the motor holder 7 and is engaged with the planetary gears 31, a carrier 34 that rotatably supports the planetary gears 31 and rotates along with the operating section 4 in accordance with the rotation of the planetary gears 31.

Each of the planet gears 31 has substantially a cylinder shape and rotational shafts 31a and 31b are coaxially formed at the central portions of both surfaces thereof.

As shown in FIG. 4, the regulating member 32 has a disc portion 32a and three coupling portions 32b that stand upright along a circumferential portion of the disc portion 32a. A center hole 32c through which the sun gear 30 passes is provided at the center of the disc portion 32a. Also, bearing holes 32d that axially support the rotational shafts 31a of the planetary gears 31 and regulating portions 32e that regulate the rotation of the carrier 34 are provided around the central hole 32c. In addition, a long anchoring hole 32f that snap-couples with the carrier 34 is provided in each of the coupling portions 32b.

The carrier 34 has a disc portion 34a, a cylindrical shaft portion 34b that is formed on the upper surface of the disc portion 34a, and three coupling portions 34c that are formed along the outer circumferential portion of the disc portion 34a. As shown in FIG. 4, the disc portion 34 is provided with bearing holes 34d that axially supports the rotational shafts 31b formed at the planetary gears 31. In addition, a thread hole 34e that couples with the mounting member 8 is formed at the central portion of the upper surface of the shaft portions 34b and anchoring claws 34f that are engaged with anchoring holes provided in the mounting member 8 are formed on the outer circumferential surface. Further, anchoring claws 34g that are engaged with the anchoring holes 32f formed in the coupling portions 32b of the regulating member 32 are formed in the central portions of the respective coupling portion 34c. Also, protrusions 34h which are inserted into the regulating holes 32e formed in the disc portion 32a of the regulating member 32 protrude from the lower ends of the respective coupling portions 34c.

The regulating member 32 and the carrier 34 are non-rotatably snap-coupled with each other by inserting the protrusions 34h into the regulating holes 32e and by coupling the anchoring claws 34g with the anchoring holes 32f. Further, the carrier 34 and the mounting member 8 are non-rotatably snap-coupled with each other by engaging the anchoring claws 34f with the anchoring holes. As shown in FIG. 3, the planetary gears 31 are housed in a space defined by snap-coupling the regulating member 32 with the carrier 34. At this time, the rotational shafts 31a are rotatably axially supported on the bearing holes 32d, and the rotational shafts 31b are rotatably axially supported on the bearing holes 34d. Therefore, the sun gear 30 and the ring gear 33 are connected to each other via the planetary gears 31.

The motor holder 7 is made of synthetic resin and has a cylinder shape so as to cover the motor 5 and the planetary gear mechanism 6. The motor holder 7 is provided with the plurality of engaging protrusions 7b which are formed in the lower portion of the outer surface thereof. The plurality of engaging protrusions 7b are fitted into engaging grooves 15d formed on the inner circumferential surface of the upper slider 15 (see FIG. 5) so as to regulate the rotation of the upper slider 15 with respect to the motor holder 7.

The mounting member 8 is made of synthetic resin and has a cap shape. A holder through hole 8a is provided at the center of the mounting member 8. The mounting member 8 is coupled with the sun gear 30 by screwing the holder passing through the holder through hole 8a with a thread hole 30a formed in the sun gear 30.

The encoder 9 includes a code plate 9a that is fixed to the output shaft 5a of the motor 5, a photo interrupter 9b that has light-emitting elements and light-receiving elements disposed, with the code plate 9a interposed therebetween, on the front and rear surfaces of the code plate 9, a wiring board 9c on which the photo interrupter 9b and required circuit parts are mounted, and a bracket 9d which fixes the photo interrupter 9b and the wiring board 9c to the motor 5. The encoder 9 counts the number of the codes formed on the code plate 9a, which are formed to pass through the photo interrupter 9b, so as to detect the rotation direction and the rotation distance of the motor 5.

The encoder holder 10 is made of synthetic resin and has a vessel shape so as to cover the encoder 9. A supporting shaft 10a is formed so as to protrude from the lower surface of the encoder holder 10. The supporting shaft 10a is inserted into a hollow pivot central shaft 11a formed on the pivot holder 11 and passes through a center hole 12a formed at the center of the rubber pusher 12. The encoder holder 10 is mounted on the lower portion of the motor holder 7 through snap-coupling.

The pivot holder 11 (motor supporting section) is made of synthetic resin and has a dish shape. The hollow pivot central shaft 11a is formed so as to protrude from the center of the lower surface of the pivot holder 11. The hollow pivot central shaft 11a is inserted into the supporting hole 2a formed in the base 2. Further, the supporting shaft 10a which protrudes from the lower surface of the encoder holder 10 is inserted into the hollow pivot central shaft 11a. In addition, a required contact pattern is formed on the upper surface of the pivot holder 11 so as to detect the press operation of the operating section 4. The contact pattern includes fixed contacts 11b which are switched by movable contacts 13b formed in the rubber spring 13. The pivot holder 11 is pivotably attached to the base 2 by inserting the pivot central shaft 11a into the supporting hole 2a formed in the base 2.

The rubber pusher 12 is made of synthetic resin and has a disc shape which is housed in the pivot holder 11. A center hole 12a, through which the supporting shaft 10a protruded from the lower surface of the encoder holder 10 passes, is provided at the center of the rubber pusher 12. The supporting shaft 10a passes through the center hole 12a and thus the rubber pusher 12 is attached to the lower surface of the encoder holder 10.

The rubber spring 13 is made of synthetic resin having superior elasticity and has a ring shape. A plurality of dome portions 13a are formed on the surface of the rubber spring 13 at the same pitch and the movable contact points 13b, which are electrically connected to the fixed contact points 11b formed on the pivot holder 11, are formed on the lower surface of the dome portions 13a. The rubber spring 13 is disposed between the pivot holder 11 and the rubber pusher 12 in a state in which the movable contact points 13b face the fixed contacting points 11b.

The lower slider 14 is made of synthetic resin having excellent slidability and has substantially an elliptical shape. First guide protrusions 14a, which are pivotably fitted into the guide grooves 1c formed in the upper surface plate 1a of the case 1, protrude from the lower surface of the lower slider 12. Second guide protrusions 14b, which are pivotably fitted into guide grooves 15e formed in the lower surface of the upper slider 15, protrude from the upper surface of the lower slider 14. The first guide protrusions 14a are formed perpendicular to the second guide protrusions 14b. The lower slider 14 is mounted on the upper surface plate 1a of the case 1 in a state in which the first guide protrusions 14a are fitted into the guide grooves 1c.

The upper slider 15 is made of synthetic resin having excellent slidability. The upper slider 15 has a ring portion 15a and four arm portions 15b which protrude radially from the outer circumference of the ring portion 15a. Four contact portions 15c, which come into contact with the outer circumferential surface of the motor holder 7, protrude from the inner circumferential surface of the ring portion 15a. Further, engaging grooves 15d, which are fitted with engaging protrusions 7b protruded from the lower portion of the outer surface of the motor holder 7, are formed at the central portions of the contact portions 15c. In addition, the guide grooves 15e, which are fitted with the second guide protrusions 14b protruded from the upper surface of the lower slider 14, are formed in the lower surface of the ring portion 15a. Meanwhile, supporting protrusions 15f, which come into contact with the lower surface of the cover member 19 and the upper surface plate 1a of the case 1, are formed on the upper and lower surfaces of the four arm portions 15b. In addition, a housing potion 15g for the cam member 16 is formed on the lower surface of one of the arm portions 15b. A cam portion 15h having the same concavo-convexes as the concavo-convexes formed in the cam member 16 is formed on the lower surface of the other arm portion 15b which is disposed so as to face the one arm portion. The upper slider 15 is integrated with the motor holder 7 by fitting the engaging protrusions 7b with the engaging grooves 15d. The upper slider 15 rotates in conjunction with the rotation of the motor holder 7 and slides in a single direction in conjunction with the pivot of the motor holder 7.

The cam member 16 is made of synthetic resin having excellent slidability and wear resistance. As shown in FIGS. 3 to 5, a petaloid cam is formed on the lower surface of the cam member 16. The petaloid cam has a central concave portion 16a that is substantially circular and comes into contact with the front end of the driving rod 17, eight circumferential concave portions that are formed at regular intervals along the circumference of the central cam groove 16a, and convex portions 16c that are formed at the boundaries of the cam grooves.

The driving rod 17 is made of synthetic resin having excellent slidability and superior wear resistance and has a rod shape. A spring receiver 17a, which comes into contact with one end of the spring 18, is formed at the center of the outer surface of the driving rod 17. When being not operated, the driving rod 17 comes into contact with the central cam groove 16a of the cam member 16 and the central cam groove 16a of the cam portion 15h formed on the upper slider 15.

The spring 18 constantly biases the spring 17 in a single direction, and a coil spring is used as the spring 18. The spring 18 and the driving rod 17 are housed in the housing concave portion 1d formed on the upper surface plate 1a of the case 1 with the driving rod 17 above the spring 18. The front end of the driving rod 17 comes into elastic contact with the cam member 16 and the cam portion 15h of the upper slider 15 constantly by an elastic force of the spring 18.

The cover member 19 prevents the lower slider 14, the upper slider 15, the driving rod 17, and the spring 18 from being separated from the case 1 and regulates the mounting height of the upper slider 15 to the upper surface plate 1a of the case 1. The cover member 19 is made of a metal plate and is fixed to the upper portion of the case 1 by screws.

The extension cover 20 covers the outer circumference of the motor holder 7 and is made of synthetic resin. The extension cover 20 includes a disc-shaped fixing portion 20a and a cylindrical cover portion 20b, which stands upright on the fixing portion 20a. The extension cover 20 is integrated with the cover member 19 by screwing the fixing portion 20a to the upper surface of the cover member 19.

Hereinafter, the operation of the haptic feedback input device having such a configuration will be described.

First, when the haptic feedback input device is not in operation, as shown in FIG. 4, the front ends of the driving rods 17 come into contact with the central cam groove 16a of the cam member 16 and the central cam groove 16a of the cam portion 15h formed in the upper slider 15 by the elastic force of the springs 18. Then, the motor 5 is held vertically against the case 1 and the base 2. In addition, the motor 5 is held at the upper switching position against the case 1 and the base 2 by the elastic force of the rubber spring 13. Further, the movable contacts 11b do not come into contact with the movable contacts 13b.

When the operating section 4 is operated in the pivot direction from the above state, as shown in FIG. 5, the motor 5 pivots in the operation direction of the operating section 4 on the pivot center O, which is the front end of the supporting shaft 10a. Then, the lower slider 14 and/or the upper slider 15 slide along the upper surface plate 1a of the case 1 accordingly. Then, the relative positions of the cam member 16 attached to the upper slider 15 and the cam portion 15h formed on the upper slider 15, and the driving rod 17 attached to the case 1 change. Next, the front end of the driving rod 17 runs over the convex portion 16c and thus the driving rod 17 moves from the central cam groove 16a to the circumferential concave portion 16b. Therefore, a user can feel the change in the elastic force of the spring 18 acting on the driving rod 17 as the click feeling, when the front end of the driving rod 17 runs over the convex portion 16c and the driving rod 17 moves from the central cam groove 16a to the circumferential concave portion 16b. Further, the user can know the distance of the pivot operation of the motor. When the user removes the operation force acting on the operating section from the above state, the driving rod 17 automatically returns to the central cam groove 16a by the elastic force of the spring 18 and returns to the state shown in FIG. 4.

In the haptic feedback input device according to the embodiment, the pivot center O of the motor 5 is disposed below the center of gravity G of the motor 5. Therefore, at the time of the pivot operation of the operating section 4, a moment, which tries to rotate the motor 5 in the pivot direction, is generated. As shown in the solid line of in FIG. 6, although the maximum value P1 of the resistance force when the driving rod 17 begins to run over the convex portion 16c decreases, the minimum value Q1 further decreases. Accordingly, the change H1 (P1-Q1) in the resistance force, which is the click feeling of the operating section 4, can be larger than that when the pivot center O of the motor 5 corresponds to the center of gravity G of the motor 5 (shown in the one-dot-chain line of FIG. 6) or that when the pivot center O of the motor 5 is disposed above the center of gravity G of the motor 5. Therefore, the operation sensibility of the operating section 4 can be improved. In addition, since the change in the resistance force H for imparting the click feeling to the operating section 4 can be increased, the elastic force of the spring, which is imparted to the driving rod 17, can be decreased. As a result, the wear resistance of the cam member 16, the cam portion 15, and the driving rod 17 can be improved.

In addition, when the operating section 4 is operated in the rotation direction, the output shaft 5a of the motor 5 rotates via the mounting member 8, the carrier 34, the regulating member 32, the planetary gears 31, and the sun gear 30. The rotation direction and the rotation distance of the output shaft 5a are detected by the encoder 9 and are outputted to the control device (not shown). The control device controls the operation of the motor 5 according to the output signals of the encoder 9 and, for example, adjusts the function of the in-vehicle electronic device. The rotational force of the motor 5 is transmitted to the operating section 4 via the sun gear 30, the planetary gears 31, the regulating portion 32, the carrier 34, and the mounting member 8. Accordingly, a required feedback force in accordance with the rotation operation state of the operating section 4 is imparted to the operating section 4.

At this time, the operating section 4 is supplied with the motor output, which is amplified in accordance with the ratio of the number of teeth of the sun gear 30 and the number of teeth of the ring gear 33. Accordingly, it is possible to impart a large feedback force to the operating section 4 using a small motor output.

In addition, when the operating section 4 is pressibly operated in the shaft direction of the output shaft 5a, a press force is transmitted to the rubber spring 13 via the mounting member 8, the motor 5, and the rubber pusher 12. Then, the dome portions 13a of the rubber spring 13 are elastically buckled. In addition, the click feeling is transmitted to the operating section 4 via the rubber pusher 12, the motor 5, and the mounting member 8. Accordingly, the operating section 4 is supplied with the click feeling in accordance with the press operation of the operating section 4. At the same time, the fixed contacts 11b formed on the pivot holder 11 are electrically connected to the movable contacts 13b formed in the dome portions 13a of the rubber spring 13. The contact signals are outputted to the control device (not shown). The control device controls the in-vehicle electronic devices based on the contacts.

In the haptic feedback input device according to the aspect of the invention, since the pivot center of the motor is disposed below the center of gravity of the motor, and the click feeling imparting unit that imparts the click feeling to the operating section is disposed above the pivot center of the motor. Accordingly, it is possible to use the moment which is generated when the operating section pivots and which tries to rotate the motor in the inclined direction. Further, the peak value of the resistance force when the driving rod begins to run over the cam ridges of the click feeling imparting unit can be decreased, thereby the operability of the operating section can be improved. In addition, since the change in the resistance force can be increased so as to impart the click feeling to the operating section, the operating feeling of the operating section can be improved. Further, the elastic force imparted to the driving body can be decreased, such that the wear resistance of the click feeling imparting unit can be improved are as follows:

1. A haptic feedback input device comprising:
an operating section that is rotatably and pivotably operated by a user;
a motor that pivots in conjunction with a pivot operation of the operating section and that imparts a required feedback force in accordance with a rotation operation of the operating section to the operating section;
a base that pivotably holds the motor via a motor supporting section; and
a click feeling imparting unit that imparts a click feeling to the pivot operation of the operating section,
wherein a pivot center of the motor is disposed below a center of gravity of the motor.

2. The haptic feedback input device according to claim 1,
wherein the pivot center of the motor is disposed on an extended line of an output shaft of the motor.

3. The haptic feedback input device according to claim 1,
wherein the motor is pressibly held on the base.
